(19) United States
(12) Patent Application Publication
(10) Pub. No.: US 2005/0133463 A1
(43) Pub. Date: Jun. 23, 2005

(54) Water filter manifold with integral valve

(76) Inventor: Richard A. Kirchner, Apple Valley, MN (US)

Correspondence Address: CUNO INCORPORATED, 400 RESEARCH PARKWAY, P. O. BOX 1018, MERIDEN, CT, 06450-1018, US

(21) Appl. No.: 10/967,666

(22) Filed: Oct. 18, 2004

Related U.S. Application Data
(60) Provisional application No. 60/512,574, filed on Oct. 17, 2003.

(51) Int. Cl. B01D 35/00

(52) U.S. Cl. 210/767; 210/418

(57) ABSTRACT

A monolithic manifold assembly provides for faster and more reliable installation of water filtration systems within appliances or other locations by incorporating a valve flow block as an integral component of the manifold. The monolithic filter manifold includes a filter receiver for selectively attaching and detaching a cartridge filter. The monolithic filter manifold can include a communications interface electrically connected to a valve assembly to selectively allow a filtered water flow through the valve flow block at the direction of an external input. The valve assembly can include at least one solenoid valve configured to sealingly interface with the valve flow block.

### RELATED APPLICATIONS

The present application is a continuation-in-part of and claims priority under 35 U.S.C. § 119(e) to U.S. Provisional Application No. 60/512,574, entitled “WATER FILTER MANIFOLD WITH INTEGRAL VALVE,” filed Oct. 17, 2003, the disclosure of which is hereby incorporated by reference to the extent not inconsistent with the present disclosure.

### BACKGROUND OF THE DISCLOSURE

The present disclosure relates generally to the field of water filtration systems. More specifically, the present disclosure relates to a monolithic filter manifold comprising an integral valve flow block to facilitate installation of a water filtration system, such as a residential water filtration system.

Water filtration systems designed for use in the home, such as refrigerator and under-sink systems can be used to remove contaminants from water supplies. Due to increasing quality and health concerns with regard to municipal and well-water supplies, the popularity of such filtrations systems has increased markedly in recent years. For example, the inclusion of water filtration systems in refrigerators, once considered a luxury feature, is now included as a standard feature in all but entry level refrigerator designs.

A typical residential water filtration system generally includes a distribution manifold configured to accept a prepackaged cartridge filter. The distribution manifold is typically adapted to connect either directly or indirectly to the residential water supply and to points of use and may even allow for a drain connection. Generally, the prepackaged cartridge filter sealingly engages the distribution manifold such that an inlet flow channel connecting the residential water supply and the cartridge filter is defined, and at least one outlet flow channel connecting the cartridge filter and the points of use and/or the drain is defined.

In some current water filtration system designs, the distribution manifold includes a pair of outlet flow paths for distributing filtered water. Generally, one of the outlet flow paths supplies water to an automated ice maker while the second outlet flow path supplies water to a user operated faucet for delivering filtered water for drinking, cooking or a variety of alternative uses. To properly channel filtered water through the appropriate filtered water outlet channel, water filtration systems typically include valves mounted between the distribution manifold and the points of use. These valves are separately installed and require additional time to individually wire and leak check.

### SUMMARY OF THE DISCLOSURE

A distribution manifold of the present disclosure provides for faster and more reliable installation of water filtration systems within appliances. Generally, the distribution manifold is manufactured as a monolithic assembly having a valve flow block as an integral component of the distribution manifold such that additional downstream valves may not be used. The valve flow block is a portion of the ultimate valve structure generally with the valve seat, but as a part of the unitary, monolithic structure, the valve flow block is only a portion of the monolith with this valve component. The monolithic distribution manifold can comprise a plug connector or the like, wired to a valve structure to promote a quick, simple and reliable electrical interconnection between the distribution manifold and a control system. The valve flow block can be a component of a valve structure incorporating suitable valve designs, for example, solenoid valves. When the valve structure comprises solenoid valves, the valve structure can further incorporate rectifiers or the solenoid valves can be configured for DC power such that the solenoid valves provide for quiet operation with less heat generation. While the monolithic manifold can be held together with reversible fasteners in some representative embodiments, as described below, the monolithic structure is distinguishable from a non-monolithic structure in that the monolithic structure comprises a single unit having no flow connections within the monolithic structure that connect tubing, piping or the like with a flow channel.

In one representative embodiment, the present disclosure describes a monolithic manifold assembly. The monolithic manifold assembly can incorporate a variety of integral components such as an inlet, an outlet, a flow channel, a filter receiver and a valve flow block. The monolithic manifold assembly can comprise an electrical connector for interconnecting a valve structure with a control element to selectively allow flow through the valve flow block. The monolithic manifold assembly can comprise a stacked plate arrangement for partially defining the flow channel.

In another representative embodiment, the present disclosure describes a water filtration system comprising a monolithic manifold assembly and a replaceable cartridge filter. The monolithic manifold assembly can comprise a filter receiver allowing for quick and convenient attachment of the cartridge filer, for example through rotatable or slidable connecting members.

In another representative embodiment, the present disclosure describes a method for reducing the potential for leak point in a water filtration system by eliminating the need for downstream distribution valves. A monolithic manifold assembly can be fabricated to include an integral valve flow block such that downstream distribution valves may not be used or needed. The monolithic manifold assembly can be permanently connected, for example by suitable welding, molding or adhesive joining techniques, as would be known to those skilled in the art and all new techniques that may be subsequently developed that perform the same function. Alternatively, the monolithic manifold assembly can be detachable connected, for example through the use of suitable clamps, bolts or other connectors, allowing for the replacement of components, as would be known to those skilled in the art and all new techniques that may be subsequently developed that perform the same function.

In still another representative embodiment, the present disclosure describes an appliance, such as, for example, a refrigerator comprising a water filtration system designed to reduce the potential for downstream system leakage. The water filtration system can comprise a valve flow block to selectively distribute a filtered water stream to points-of-use on the appliance, such as, for example, a manual water dispenser or tap in a refrigerator door or an automated device, such as, for example, an icemaker.

The above summary of the various aspects of the present disclosure is not intended to describe in detail each illustrated representative embodiment or the details or every possible implementation of the present disclosure. The figures in the detailed description that follow more particularly exemplify these representative embodiments. These, as well as other objects and advantages of the present disclosure, will be more completely understood and appreciated by referring to the following more detailed description of the described representative, exemplary embodiments of the present disclosure in conjunction with the accompanying drawings.

### BRIEF DESCRIPTION OF THE DRAWINGS

FIG. 1 is an exploded, perspective view of an embodiment of a monolithic manifold assembly of the present invention with hidden springs shown for later reference.

FIG. 2 is an alternative exploded, perspective view of the monolithic manifold assembly of FIG. 1.

FIG. 3 is a second alternative exploded, perspective view of the monolith manifold assembly of FIG. 1.

FIG. 4 is an exploded, perspective view of a filtration system according to an embodiment of the invention.

FIG. 5 is an end view of a valve flow block according to an embodiment of the invention.

FIG. 6 is a top view of the valve flow block of FIG. 5.

FIG. 7 is a section view of the valve flow block of FIG. 5 taken along line 7-7 of FIG. 6.

FIG. 8 is a partial section view of an appliance including a filtration system according to an embodiment of the invention.

### DETAILED DESCRIPTION OF PRESENTLY PREFERRED REPRESENTATIVE EMBODIMENTS

An improved monolithic manifold assembly for use in filtration systems comprises a valve flow block to selectively direct a filtered water flow to a desired point-of-use. Generally, the monolithic manifold assembly can be fixedly attached to a surface, such as the interior of an appliance or a cabinet. Replaceable cartridge filters can be connected and removed appropriately, for example, rotatably or slidingly in a longitudinal, a lateral or angled direction, from the manifold. In particular, a cartridge filter can be replaced as the filtering capacity of the cartridge filter is consumed or exhausted. The manifold assembly can comprise a fastener component that cooperates with a compatible fastener component on the cartridge filter to create an operable water filtration system with flow channels passing through the manifold and the cartridge filter. The manifold assembly also comprises inlet and outlet flow channels that define continuous flow paths from a water source, through the water filtration system and to one or more points of use or to drain at the direction of the valve flow block. The term “block” in valve flow block does not indicate any particular shape or the separate assembly into the monolithic structure, but the valve flow block as a feature of the monolithic manifold contributes a portion of the ultimate valve structure, such as generally the valve seat.

The monolithic manifold assembly as described herein comprises an integral valve flow block located to interface with the inlet flow channels or outlet flow channels. A valve structure can comprise at least one valve to selectively allow filtered water to flow through the valve flow block and to points of use based on an input from an external control. The external control can receive signals from various points-of-use including a water tap or automated ice machine requesting filtered water flow.

The valve flow block is an integral component of the monolithic manifold assembly such that no significant additional installation time is required to install downstream distribution valves at the time of installation of the water filtration system. Through the elimination of downstream distribution valves, the number of potential leak points within the water filtration system is reduced. The entire valve assembly can be installed on the valve flow block.

The monolithic manifold assembly can further comprise a plug-style connector for completing a control circuit between a control unit and a valve assembly interfacing with the valve block flock structure to further simplify wiring requirements between the control unit and the valve. The control unit can be mounted, for example, on the monolithic manifold structure, in an appliance associated with the manifold or remotely. In one representative embodiment, the valve assembly can comprise a pair of solenoid valves that sealing interface with the valve flow block. The valve assembly can be fabricated to reduce operating temperature by, for example, operating on DC power or to reduce operation noise through the inclusion of rectifiers on the solenoid valves. In alternative representative embodiments, alternative valve designs having suitable performance and assembly characteristics could be used with the valve assembly.

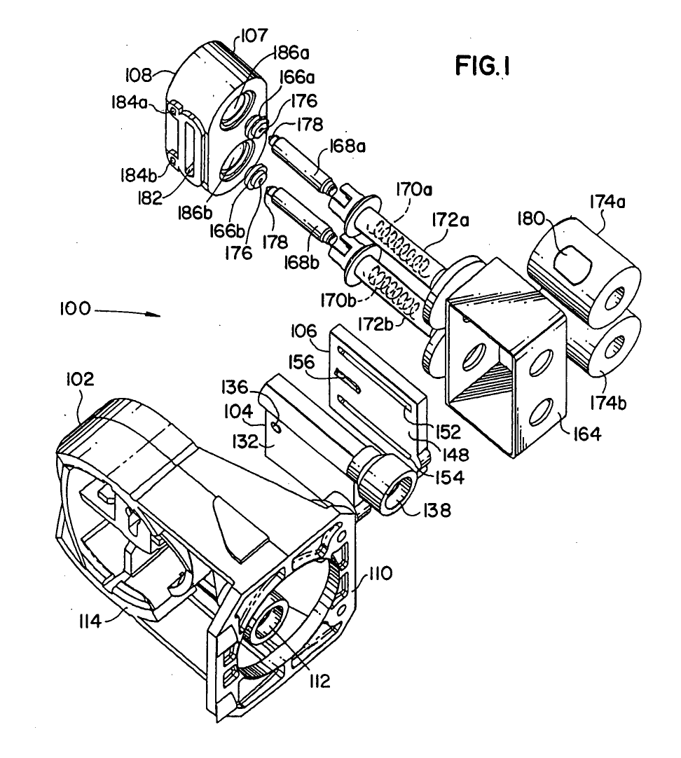

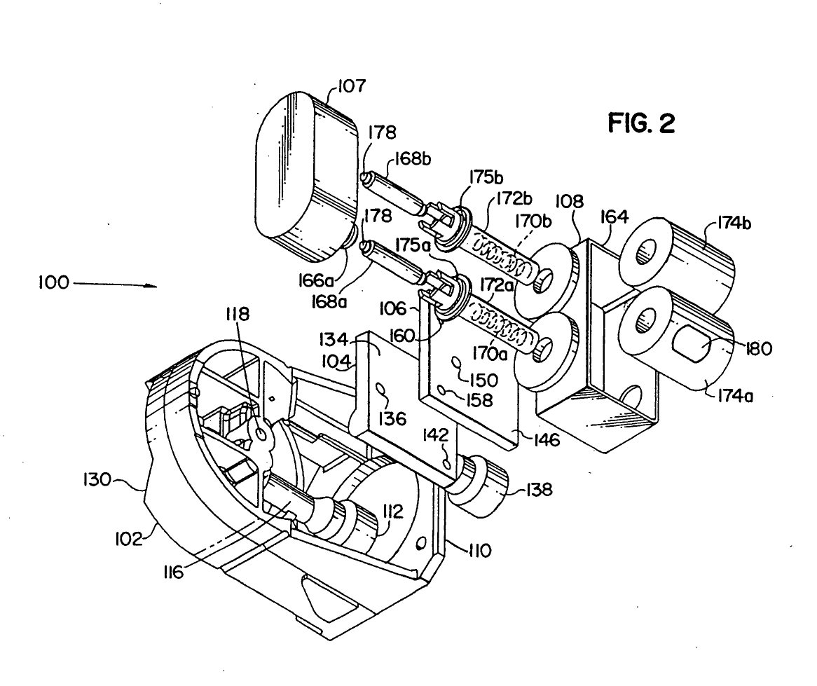

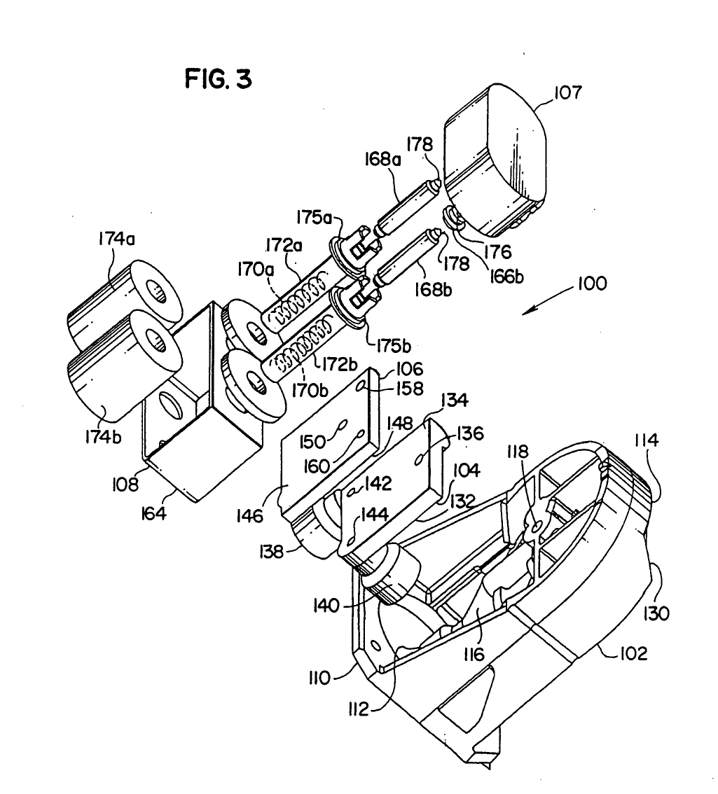

As illustrated in one representative embodiment of FIGS. 1, 2 and 3, a monolithic manifold assembly 100 comprises a manifold body 102, a first flow plate 104, a second flow plate 106, a valve flow block 107 and a valve assembly 108. Manifold body 102 has a mounting surface 110, an unfiltered water inlet 112 and a filter interface surface 114. Water inlet 112 is fluidly connected to an inlet flow channel 116. Manifold body 102 also includes a filtered water manifold outlet 118. Manifold assembly 102 is comprised of a metal, a ceramic, a polymeric material or a combination thereof, as would be appreciated by those skilled in the art and all new materials that may be subsequently developed that are capable of performing the same function. Suitable polymers include polyolefins such as polypropylene, polyethylene, polycarbonate or combinations thereof, as would be appreciated by those skilled in the art and all new polymers that may be subsequently developed that are capable of performing the same function.

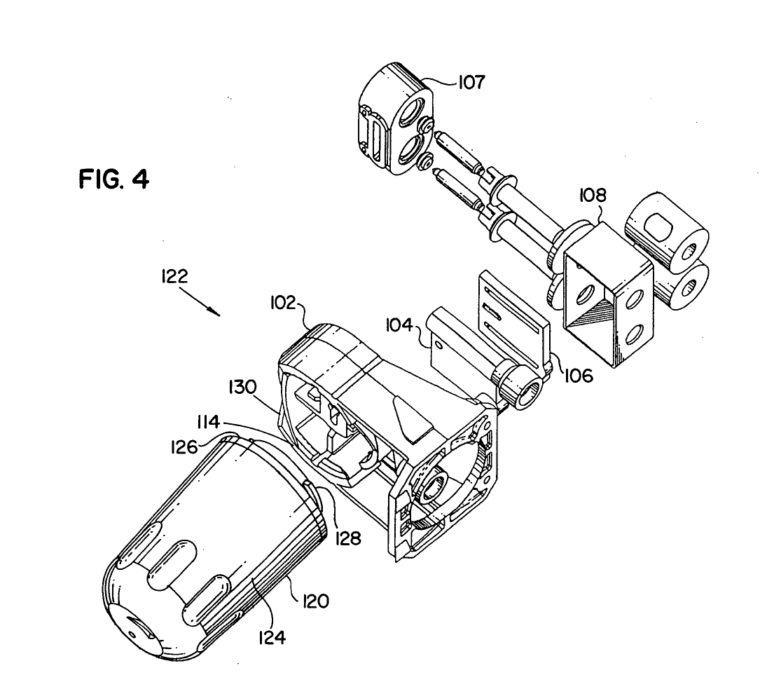

Manifold body 102 is generally adapted to connect with a cartridge filter 120 to form a filtration system 122 as depicted in FIG. 4. Cartridge filter 120 can comprise a unitary structure formed by a cartridge housing 124 and a cartridge cap 126. Cartridge cap 126 can comprise a connecting member 128, such as, for example, angled tabs or ramps that cooperatively interface with a ramp 130 on filter interface surface 114 to promote connection of the manifold body 102 and cartridge filter 120. Suitable interconnection members and methods for rotatable interconnection are further disclosed in U.S. patent application Ser. Nos. 09/618,686, 10/196,340, 10/202,290, 10/406,637 and 10/838,140, each of which is incorporated by reference to the extent not inconsistent with the present disclosure.

In another alternative representative configuration, cartridge cap 126 and filter interface surface 114 may include attachment features to promote linear, slidable attachment of the manifold body 102 with cartridge filter 120, as described in U.S. patent application Ser. No. 10/210,890, which is herein incorporated by reference to the extent not inconsistent with the present disclosure.

Cartridge filter 120 can comprise any suitable filtering media. For example, cartridge filer 120 can comprise various types of suitable filtration media, such as, for example, powdered and granular activated carbon media, ceramic filtration media, powdered polymeric filtration media, manganese greensand, ion exchange media, cross-flow filtration media, polymeric barrier filtration or media, mineral-based fibers, granules and powders and combinations thereof, as would be appreciated by those skilled in the art and all new filtration media that may be subsequently developed that are capable of performing the same filtration function.

Referring again to FIGS. 1, 2 and 3, first flow plate 104 comprises a first connector surface 132 and a first flow surface 134. A first throughbore 136 extends through first flow plate 104 and connects first connector surface 132 with first flow surface 134. First flow plate 104 also includes a first outlet 138 and a second outlet 140. First flow surface 134 includes a first outlet bore 142 and a second outlet bore 144.

As depicted in FIGS. 1, 2 and 3, second flow plate 106 comprises a second connector surface 146 and a second flow surface 148. A second throughbore 150 extends through second flow plate 106 and connects second connector surface 146 with the second flow surface 148. Second flow surface 148 comprises a first flow recess 152, a second flow recess 154 and a third flow recess 156. Third flow recess 156 is fluidly connected to second throughbore 150. Second connector surface 146 comprises a first bore 158 fluidly connected to first flow recess 152 as well as a second bore 160 fluidly connected to second flow recess 154.

Representative valve assembly 108 comprises a bracket 164, a pair of diaphragms 166a, 166b, a pair of valve plungers 168a, 168b, a pair of springs 170a, 170b, a pair of guides 172a, 172b and a pair of solenoid coils 174a, 174b. A pair of guide seals 175a, 175b, such as, for example, O-rings or integrally molded seals conform to the guides 172a, 172b. Diaphragms 166a, 166b each comprise a diaphragm throughbore 176. Valve plungers 168a, 168b each comprise a sealing tip 178. Sealing tip 178 is dimensioned to sealingly engage the diaphragm throughbore 176. In an alternative representative embodiment, valve plungers 168a, 168b can comprise integral seals to directly engage the valve flow block 107. Solenoid coils 174a, 174b can be encased and packaged as a single component including a power connector 180 wired to the solenoid coils 174a, 174b. In alternative representative embodiments, valve assembly 108 can further comprise components that can provide for cooler and quieter operation, for example, the use of rectifiers and DC powered solenoid coils to reduce current draw and eliminate oscillation. Although valve assembly 108 is described with respect to utilizing solenoid valves, it will be understood that any suitable automatically actuatable valve could be used as well, such as, for example, pneumatic or hydraulically actuated valves as would be appreciated by those skilled in the art and all new valves that may be subsequently developed that are capable of performing the same function.

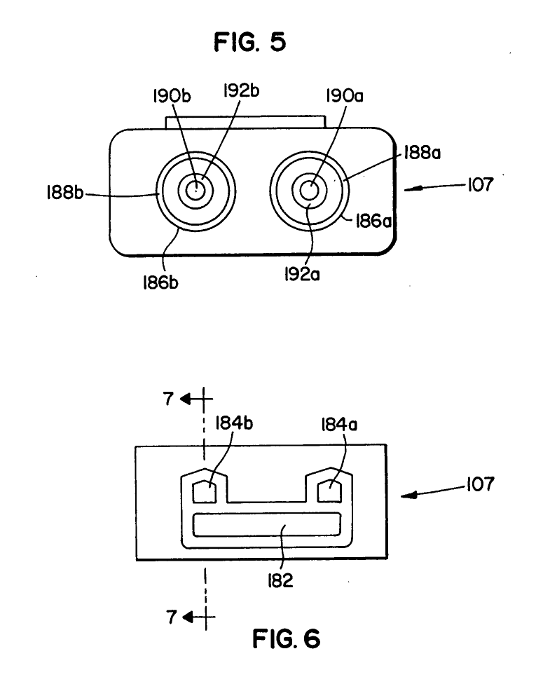

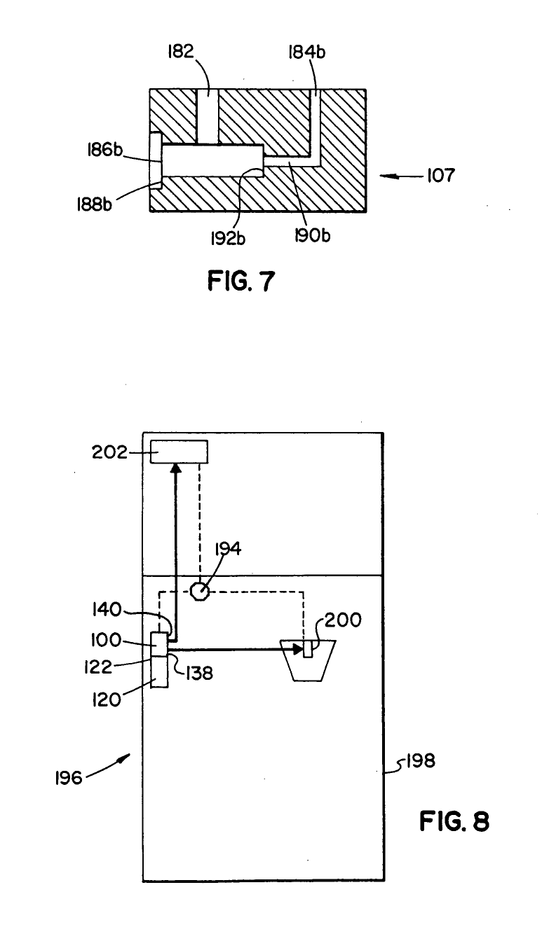

As illustrated in FIGS. 5, 6 and 7, valve flow block 107 comprises a valve inlet bore 182 and a pair of valve outlet bores 184a, 184b. Valve flow block 107 also includes a pair of valve bores 186a, 186b. Valve bores 186a, 186b each include a valve flange 188a, 188b adapted to sealingly interface with the guide seals 175a, 175b. Valve flow block 107 further includes a pair of internal flow channels 190a, 190b fluidly connecting valve inlet bore 182 with corresponding valve outlet bores 184a, 184b. For example, internal flow channel 190b is defined by the interaction of valve inlet bore 182, valve bore 186b and valve outlet bore 184b, as illustrated in FIG. 7. It will be understood that internal flow channel 190a is similarly defined by valve inlet bore 182, valve bore 186a and valve outlet bore 184a. Internal flow channels 190a, 190b include channel flanges 192a, 192b adapted to sealingly interact with the corresponding diaphragms 166a, 166b and valve plungers 168a, 168b. While the manifold assembly has been described with respect to the figures as having two outlets, similar structures with one outlet, three outlets or more outlets can be formed based on the teachings herein. Similarly, while a valve flow block has been depicted with two valve seats, separate flow blocks can be formed for a plurality of valve structures and a variety of configurations can be adapted from the teachings herein.

Prior to use, components of monolithic manifold assembly 100 are assembled to form a unitary assembly. First flow plate 104 and second flow plate 106 are positioned with first flow surface 134 and second flow surface 148 in proximity such that first throughbore 136 and second throughbore 150 are substantially in alignment while first outlet bore 142 is located proximally to first flow recess 152 and second outlet bore 144 is located proximally to second flow recess 154. First flow plate 104 and second flow plate 106 are then operatively connected through a suitable bonding process, such as, for example, permanent joining through the use of adhesives, appropriate welding technologies such as sonic welding, molding such as injection molding or through the use of snap-fit members as would be appreciated by those skilled in the art and all new bonding processes that may be subsequently developed that are capable of performing the same joining function. Alternatively, first flow plate 104 and second flow plate 106 can be detachably joined through the use of suitable clamps, bolts or other fasteners. In an alternative representative embodiment, first flow plate 104 and second flow plate 106 can be integrally molded to form a single, unitary flow plate. Once first flow plate 104 and second flow plate 106 are joined, an inlet circuit is defined by first throughbore 136 and second throughbore 150, a first outlet circuit is defined by first bore 158, first flow recess 152 and first outlet 138 while a second outlet circuit is defined by second bore 160, second flow recess 154 and second outlet 140.

Valve flow block 107 and valve assembly 108 can be operably connected by placing diaphragm 166a within the corresponding valve bore 186a. An end opposed to sealing tip 178 of plunger 168a is directed into guide 172a such that plunger 168a is in contact with spring 170a. Guide 172a is operatively positioned through the center opening on solenoid coil 174a. Sealing tip 178 can be operatively positioned within valve bore 186a such that sealing tip 178 is in proximity to diaphragm throughbore 176. The process can be similarly repeated with diaphragm 166b placed within valve bore 186b. An end opposed to sealing tip 178 of plunger 168b is directed into guide 172b such that plunger 168b is in contact with spring 170b. Guide 172b is positioned within the center opening on solenoid coil 174b. Sealing tip 178 can be positioned within valve bore 186b such that sealing tip 178 is in proximity to diaphragm throughbore 176. The order of assembly for valve flow block 107 and valve assembly 108 as described above is for descriptive purposes only and it will be understood that a user might select any number of possible alternative orders of assembly without departing from the spirit and scope of the present invention.

Valve flow block 107 can then be positioned with respect to second flow plate 106. Specifically, valve inlet bore 182 can be aligned with second throughbore 150 while valve outlet bore 184a can be aligned with first bore 158. In addition, valve outlet bore 184b can be aligned with second bore 160. Valve flow block 107 is then coupled to second flow plate 106. Valve flow block 107 can be permanently attached to second flow plate 106 through a suitable molding, welding, snap-fit or adhesive joining process, as would be appreciated by those skilled in the art and all new boding processes that may be subsequently developed that are capable of performing the same bonding function. Alternatively, valve flow block 107 can be removably attached to second flow plate 106, for example through the use of suitable clamps, bolts or other fasteners, as would be appreciated by those skilled in the art and all fasteners that may be subsequently developed that are capable of performing the same fastening function. Alternatively, valve flow block 107 and second flow plate 106 can be integrally molded as a single, unitary component.

Also, first flow plate 104 can be positioned with respect to manifold body 102. First throughbore 136 is aligned with water manifold outlet 118. First flow plate 104 is then coupled to manifold body 102. First flow plate 104 can be permanently attached to manifold body 102 through a suitable molding, welding, snap-fit or adhesive joining process, as would be appreciated by those skilled in the art and all new bonding processes that may be subsequently developed that are capable of performing the same joining function. Alternatively, first flow plate 104 can be removably attached to manifold body 102, for example through the use of suitable clamps, bolts or other fasteners, as would be appreciated by those skilled in the art and fasteners that may be subsequently developed that are capable of performing the same fastening function. Alternatively, first flow plate 104 and manifold body 102 can be integrally molded as a single, unitary component.

After permanently or reversibly assembling monolithic manifold assembly 100 as described above, the monolithic manifold assembly 100 can be operatively positioned using mounting surface 110 for use in an appliance such as a refrigerator. A cartridge filter 120 can be sealingly coupled, such as, for example, slidingly or rotationally as previously described, to filter interface surface 114. Once the cartridge filter 120 has been attached to the monolithic manifold assembly 100, two flow channels are defined; one extending from unfiltered water inlet 112 to first outlet 138 while the other extends from unfiltered water inlet 112 to second outlet 140.

In use, supply water enters monolithic manifold assembly 100 through unfiltered water inlet 112. Water then flows through inlet flow channel 116 and into cartridge filter 120 wherein the water is filtered to remove contaminants. Filtered water flows out of water manifold outlet 118, through first throughbore 136, into third flow recess 156, out of second throughbore 150 and into valve flow block 107 through valve inlet bore 182. Flow into respective outlets is controlled with valve assemblies 108.

Using power connector 180, the solenoid coils 174a, 174b can be wired to a control unit 194 within an appliance 196 as illustrated in FIG. 8. Control unit 194 can comprise any suitable control element such as a Programmable Logic Controller (PLC), a microprocessor, a logic circuit comprising relays and/or a terminal block. Appliance 196 can be selected from suitable appliances such as refrigerators and water coolers. Control unit 194 can selectively control the flow of water through monolithic manifold assembly 100 based upon manual or automated signals from the control unit 194 to the monolithic manifold assembly 100. In some representative embodiments, control unit 194 can be mounted itself onto monolithic manifold assembly 100 with appropriate connections to receive input signals. Furthermore, components of control unit 194 can be mounted at different physical locations with appropriate communication between the components.

When an input to the control unit 194 indicates that filtered water is desired, the control unit 194 can individually or simultaneously energize solenoid coils 174a, 174b. When solenoid coils 174a, 174b are not energized, springs 170a, 170b bias the sealing tip 178 of valve plungers 168a, 168b such that the diaphragm throughbore 176 of diaphragms 166a, 166b remain closed preventing filtered water from flowing past the valve flow block 107. When the control unit 194 signals that filtered water is desired, the control unit 194 energizes the appropriate solenoid coil. For example, the control unit 194 energizes solenoid coil 174b resulting in plunger 168b withdrawing the sealing tip 178 from diaphragm throughbore 176 of diaphragm 166b such that filtered water flows through diaphragm throughbore 176, through the internal flow channel 190b into out the valve outlet bore 184b. Filtered water from valve outlet bore 184b flows into second bore 160, through second flow recess 154 and to points of use through second outlet 140. As would be understood by one skilled in the art, a similar process occurs with respect to energizing solenoid coil 174a such that filtered water can subsequently flow to points of use through first outlet 138. As shown in FIG. 5, first outlet 138 can supply a refrigerator 198 having a door mounted faucet 200 for supplying filtered water for domestic consumption while second outlet 140 can supply an automated feature such as an icemaker 202.

While the use and assembly of the present invention has been described, it will be obvious to one skilled in the art that various modifications and additions can be incorporated without departing from the spirit and scope of the present invention.

1. A filter manifold comprising:
a monolithic manifold structure comprising an inlet, an outlet, a flow channel, a filter receiver, and a valve flow block integral to the monolithic manifold structure and fluidly connected with the flow channel.

2. The filter manifold of claim 1, further comprising a valve assembly connected to the valve flow block to form a valve, the valve assembly selectively controlling flow a water flow within the flow channel.

3. The filter manifold of claim 2, further comprising an electronic communications interface attached to the monolithic manifold body and electrically connected to the valve assembly, the valve assembly interfacing with the valve flow block to selectively regulate a filtered water flow through the valve flow block at the direction of an external control.

4. The filter manifold of claim 2, wherein the valve comprises a solenoid valve having a valve plunger interfacing with the valve flow block to selectively allow the water flow through the flow channel.

5. The filter manifold of claim 1 wherein the flow channel is at least partially defined by a stacked plate arrangement, the stacked plate arrangement comprising a first flow plate operably joined to a second flow plate, the first flow plate comprising a first supply bore, a first outlet bore in fluid communication with the outlet, the second flow plate comprising a second supply bore, a second outlet bore and a second outlet recess wherein the first supply bore and the second supply bore define an inlet circuit and wherein the second outlet bore, second outlet recess, first outlet bore and the outlet define a first outlet circuit.

6. The filter manifold of claim 1, wherein the valve flow block is within the flow channel between the filter receiver and the outlet.

7. The filter manifold of claim 1, wherein the valve flow block is within the flow channel between the filter receiver and the inlet.

8. The filter manifold of claim 1, further comprising a second outlet and a second valve flow block wherein the second valve flow block is fluidly connected to the flow channel between the filter receiver and the second outlet.

9. The filter manifold of claim 1, further comprising a second outlet and wherein the valve assembly forms a second valve connected to the valve flow block.

10. A filtration system comprising the filter manifold of claim 1, and a filter cartridge attached to the filter manifold at the filter receiver to form a continuous flow channel from the inlet to the outlet through the valve flow block.

11. The filtration system of claim 10, wherein the filter cartridge is rotatably attachable to the filter manifold to define the continuous flow channel.

12. The filtration system of claim 10, wherein the filter cartridge is slidably attachable to the filter manifold to define the continuous flow channel.

13. A filter manifold comprising:
a monolithic manifold body comprising an inlet, a plurality of outlets, a filter receiver, and a flow channel, the flow channel fluidly connecting the inlet and the filter receiver and the flow channel comprising a flow branch between the filter receiver and the plurality of outlets.

14. The filter manifold of claim 13, wherein the flow branch comprises a valve flow block having a pair of block flow circuits.

15. The filter manifold of claim 14, further comprising a valve assembly selectively interfacing with the pair of block flow circuit, the valve assembly comprising a pair of valves and a communications interface connected to a control unit wherein the control unit selectively actuates each valve to regulated a water flow through each block flow circuit.

16. The filter manifold of claim 15, wherein each valve comprises a solenoid valve for selectively interfacing with the block flow circuits.

17. The filter manifold of claim 13, wherein the monolithic manifold body further comprises a filter receiver for selectively attaching a cartridge filter, the filter receiver in fluid communication with the flow channel.

18. The filtration system of claim 17, wherein the cartridge filter is rotatably attachable to the filter receiver to define the continuous flow channel.

19. The filter manifold of claim 13, wherein the fluid channel is at least partially defined by a stacked plate arrangement, the stacked plate arrangement comprising a first flow plate operably joined to a second flow plate, the first flow plate comprising a first supply bore, a first outlet bore in fluid communication with the outlet, the second flow plate comprising a second supply bore, a second outlet bore and a second outlet recess wherein the first supply bore and the second supply bore define an inlet circuit and wherein the second outlet bore, second outlet recess, first outlet bore and the outlet define a first outlet circuit.

20. A filtration system comprising:
a monolithic filter manifold comprising an inlet, an outlet, a flow channel, a filter receiver, and an integral valve flow block fluidly connected with the flow channel, and
a cartridge filter comprising a filter housing, a filter connector and a filter media,
wherein the cartridge filter is fluidly connected to the monolithic filter manifold through interconnection of the filter connector and the filter receiver such that a flow circuit is defined between the inlet and the outlet; and
wherein a valve assembly selectively interfaces with the valve flow block to control flow through the outlet.

21. The filtration system of claim 20, wherein the filter media comprises powdered or granular activated carbon media, ceramic filtration media, powdered polymeric filtration media, manganese greensand, ion exchange media, cross-flow filtration media, polymeric barrier filtration media, mineral-based fibers, granules or powders or combinations thereof.

22. The filtration system of claim 20, wherein the monolithic filter manifold further comprises a communication interface, the communication interface being electrically interconnected to the valve assembly to selectively interface at least a first valve with the valve flow block such that that the filtered water flow is directed through the first outlet based upon an external input.

23. The filtration system of claim 22, wherein the first valve comprises a solenoid valve having a valve plunger sealably interfacing with the valve flow block.

24. The filtration system of claim 22, wherein the valve assembly comprises a second valve interfacing with the valve flow block such that the first valve selectively directs water to the first outlet and the second valve selectively diverts water to a second outlet on the valve flow block.

25. The filtration system of claim 20, wherein the filter connector is rotatably engagable with the filter receiver.

26. An appliance comprising the filtration system of claim 20.

27. A method for filtering water while reducing downstream installation connections comprising:
fabricating a monolithic filter manifold comprising an inlet, a filter receiver and a valve flow block, the valve flow block having a water inlet and a filtered water outlet for distributing a filtered water stream.

28. The method of claim 27, further comprising:
connecting a cartridge filter to the filter receiver to define a continuous fluid circuit between the water inlet and the filtered water outlet.

29. The method of claim 27, further comprising:
connecting the filtered water outlet directly to a point-of-use.

30. The method of claim 27, further comprising:
mounting a valve assembly to the valve flow block such that a valve selectively interfaces with the valve flow block, the valve assembly receiving an external signal whereby the valve is selectively positioned to direct the filtered water stream through the filtered water outlet.

31. The method of claim 27, wherein fabricating the monolithic filter manifold comprises permanently joining the monolithic filter manifold with a welding process, a molding process, a snap-fit process, an adhesive process or combinations thereof.

32. The method of claim 27, wherein fabricating the monolithic filter manifold comprises detachably joining the monolithic filter manifold with a clamping process, a fastening process or combinations thereof.
